(19) United States
(12) Patent Application Publication
(10) Pub. No.: US 2015/0270980 A1
(43) Pub. Date: Sep. 24, 2015

(54) DEVICE-BASED DATA SHARING

(71) Applicant: International Business Machines Corporation, Armonk, NY (US)

(72) Inventors: David B. Lection, Raleigh, NC (US); Ruthie D. Lyle, Durham, NC (US); Eric L. Masselle, Raleigh, NC (US); William G. Pagan, Durham, NC (US)

(73) Assignee: International Business Machines Corporation, Armonk, NY (US)

(21) Appl. No.: 14/220,319

(22) Filed: Mar. 20, 2014

(51) Int. Cl. H04L 12/18; H04L 29/08

(52) U.S. Cl. CPC H04L 12/1813; H04L 67/141

(57) ABSTRACT

According to some embodiments, a computer-implemented method includes joining a first device to a first group of one or more other devices. It is determined that a first set of filtering conditions is met by media contributed by the first device. A media control is applied, by a computer processor, to the contributed media to provide controlled media. The controlled media is a controlled version of the contributed media, and the media control application is performed automatically in response to the first set of filtering conditions for the contributed media being met. The controlled media is shared with the other devices in the first group, automatically in response to the first set of filtering conditions for the contributed media being met.

### BACKGROUND

Various embodiments of this disclosure relate to data sharing and, more particularly, to sharing media across organized groups of devices.

The current age of technology places a significant focus on media, including photos, audio, video, and even three-dimensional and virtual reality snippets. Media can be shared with friends and family, by emailing or by posting on social networks. Given the large amounts of media currently available, however, and with numerous devices producing and consuming that media, it becomes problematic to share media in efficient ways.

### SUMMARY

In one embodiment of this disclosure, a computer-implemented method includes joining a first device to a first group of one or more other devices. It is determined that a first set of filtering conditions is met by media contributed by the first device. A media control is applied, by a computer processor, to the contributed media to provide controlled media. The controlled media is a controlled version of the contributed media, and the media control application is performed automatically in response to the first set of filtering conditions for the contributed media being met. The controlled media is shared with the other devices in the first group, automatically in response to the first set of filtering conditions for the contributed media being met.

In another embodiment, a system includes a group manager, a media controller, and a communications manager. The group manager is configured to join a first device to a first group of one or more other devices, and to determine that a first set of filtering conditions is met by media captured on the first device. The media controller is configured to apply a media control to the contributed media to provide controlled media. The controlled media is a controlled version of the contributed media, and the media control application is performed automatically in response to the first set of filtering conditions for the contributed media being met. The communications manager is configured to share the controlled media with the other devices in the first group, automatically in response to the first set of filtering conditions for the contributed media being met.

In yet another embodiment, a computer program product includes a computer readable storage medium having computer readable program code embodied thereon. The computer readable program code is executable by a processor to perform a method. The method includes joining a first device to a first group of one or more other devices. Further according to the method, it is determined that a first set of filtering conditions is met by media contributed by the first device. A media control is applied, by a computer processor, to the contributed media to provide controlled media. The controlled media is a controlled version of the contributed media, and the media control application is performed automatically in response to the first set of filtering conditions for the contributed media being met. The controlled media is shared with the other devices in the first group, automatically in response to the first set of filtering conditions for the contributed media being met.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computer system for implementing a sharing system or method, according to some embodiments of this disclosure;

FIG. 2 is a block diagram of the sharing system, according to some embodiments of this disclosure; and

FIG. 3 is a flow diagram of a method for sharing between devices, according to some embodiments of this disclosure.

### DETAILED DESCRIPTION

According to some embodiments of this disclosure, sharing systems and methods provide social networking features to computing devices, as opposed to the users of those devices. In contrast to conventional social networks, where accounts are tied to humans and can be accessed through various devices, the sharing systems and methods may enable the devices themselves to be group members for the purpose of sharing. As a result, media sharing may become organized more efficiently, and media may be more easily integrated with users' devices.

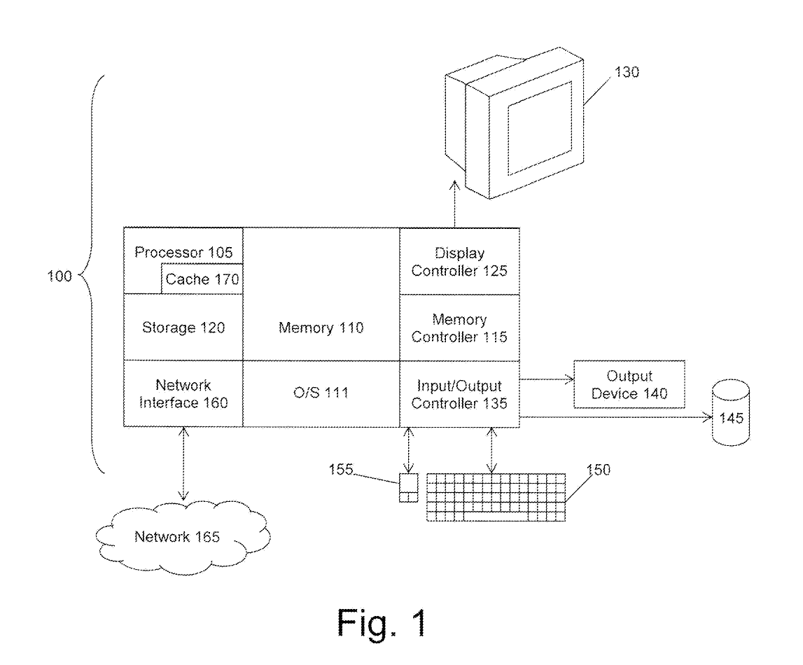

FIG. 1 illustrates a block diagram of a computer system 100 for use in implementing a sharing system or method according to some embodiments. The sharing systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a smartphone, camera, tablet, GPS unit, personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the sharing systems and methods of this disclosure.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Sharing systems and methods according to this disclosure may be embodied, in whole or in part, in computer program products or in computer systems 100, such as that illustrated in FIG. 1.

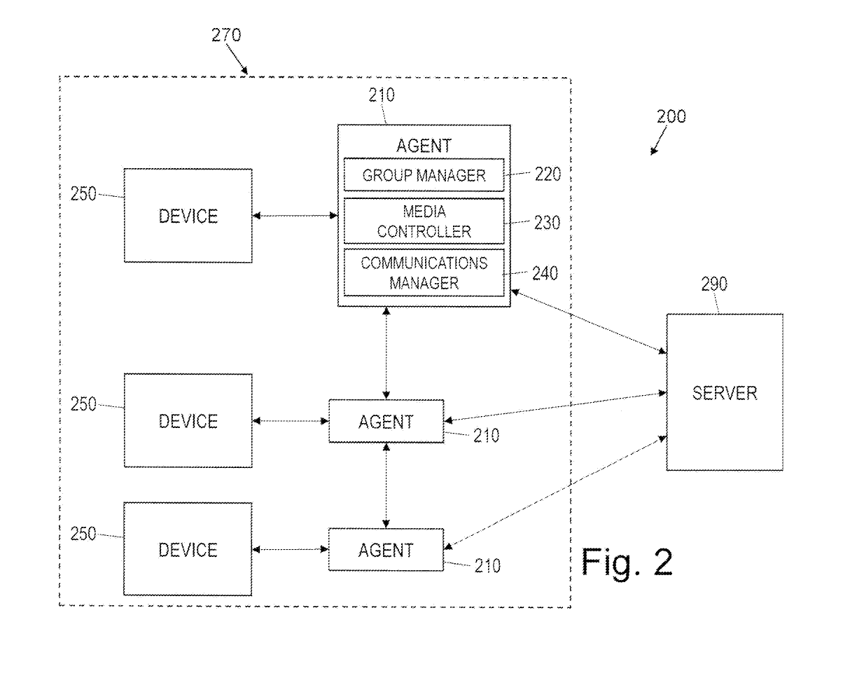

FIG. 2 is a block diagram of a sharing system 200 according to some embodiments of this disclosure. As shown, the sharing system 200 may include two or more agents 210, each running on a corresponding device 250. The devices 250 may be computer systems 100, such as that shown in FIG. 1. For further example, a device 250 may be a mobile phone, smartphone, tablet computer, notebook or desktop computer, digital camera, networked attached storage device, digital photo frame, audio recorder, or other device configured to maintain or capture media or other data. In some embodiments, the sharing system 200 may further include one or more central servers 290, which may communicate with the agents 210 to facilitate data sharing between the various devices 250. The central server 290 need not be included, however, as file-sharing may occur through peer-to-peer communications. Each device 250 may belong to one or more groups 270, where each group includes two or more devices 250 between which media may be shared. Further, the devices 250 within a group 270 need not belong to a single user, but may instead belong to multiple users.

For the purposes of this disclosure, media may include data arranged in files and streams that provide one or more users, when rendered, with a single- or multi-sense interactive experience. Media types applicable to some embodiments of the sharing system 200 include, for example, photos, video, Virtual Reality Modeling Language (VRML) segments, streams, audio, and the like. Future media types may also be used with embodiments of the sharing system 200, when such media types created and envisioned as technology advances. For example, work has been completed to add olfactory sensing to a computer. Resulting stored information may then be stored as a media file or stream and shared through the sharing system 200.

Additionally, it will be understood that, although this disclosure repeatedly refers to the sharing of media across devices 250, it will be understood that the sharing system 200 need not be limited to media. Rather, the sharing system 200 may alternatively, or additionally, be used to share other forms of data. Further, although this disclosure repeatedly refers to devices 250 as sharing “captured” media, it need not be necessary that the media shared is actually captured on the device 250 that is sharing it. Rather, for example, that media may be otherwise contributed by the device 250 and shared, such as by being loaded by a user onto the device 250.

Each agent 210 may be software, hardware, or a combination thereof, and may reside or run on a corresponding device 250. An agent 210 may include a group manager 220, a media controller 230, and a communications manager 240. Generally, the group manager 220 may manage information about the groups 270 to which the corresponding device 250 belongs, and may maintain preferences related to each group 270. The media controller 230 may apply medial controls as needed before that media is shared with other devices 250. The communications manager 240 may transmit shared media to the central server 290 or to other devices 250 within the corresponding device's groups 270, and may receive shared media from other devices. The communications manager 240 may thus be in communication with a communications device, such as a network card, on the corresponding device 250.

It will be understood that, while these aspects of the agent 210 are shown in FIG. 1 as being distinct, such distinction is shown for illustrative purposes only. The software, hardware, or both used to implement the group manager 220, the media controller 230, and the communications manager 240 may overlap or may be further divided, depending on the specific implementation used. It will be further understood that the sharing system 200 may be implemented as a client-server system, using the central server 290 as the server and the various devices 250 as the clients; as a completely peer-to-peer system among the devices 250; or as some hybrid configuration.

As mentioned above, a device 250 may belong to one or more groups 270, where media sharing may occur within each group 270. A group may be initiated in various ways. For example, and not by way of limitation, a user at a first device 250 may use the agent 210 on the first device 250 to transmit an invite to one or more other users or devices 250. To transmit an invite to a device 250, the inviting user may provide an identifier, such as a MAC address or an IP address of the device 250 to be invited. The invite may be communicated to the agent 210 of the invited device 250 through peer-to-peer communications, through the central server 290, or through a combination of both these techniques. If the invite is accepted by a user on the invited device 250, then that device 250 may become part of the group 270 in question. Alternatively, if the invite is sent to a user instead of to a specific device 250, the invitation may be transmitted via email or other means. In that case, the device 250 on which the invited user accepts the invitation, or a device 250 specified by the invited user, may become a part of the group 270. It will be understood that various other mechanisms may be used to form or join a group 270.

After a group is formed, some or all media captured at a first device 250 in the group 270 may be automatically transmitted to the other devices 250 in the group 270. This transmission may occur, for example, through peer-to-peer networking, using the central server 290, or through a combination of these techniques. Unlike in conventional social networking, where shared media is available online when a user logs into an online account, sharing according to some embodiments may include sharing with specific devices 250. When media is shared with a first device 250 from a second device 250 within a mutual group 270, that media may appear on the first device 250, as if it were originally captured on the device 250. This may be similar to cloud storage, or in some embodiments, the shared media may be transmitted to and stored locally on the first device 250. For example, a particular device 250 may be a digital camera, capable of capturing media in the form of digital photographs and videos. When the camera captures media, the sharing system 200 may share that media with other devices 250 in one or more of the camera's groups 270.

In some embodiments, a user of a first device 250 may desire to share media but may also wish to limit access to only a portion of the media. Conventionally, encryption is sometimes used to limit file access. According to some embodiments of this disclosure, however, encryption may not be the best approach; it would increase difficulty in accessing the media rather than provide only a partial access. Partial access may instead be provided through media conversion before sharing.

Accordingly, the agent 210 of the first device 250 may apply controls to media before it is shared with other devices 250 in the first device's groups 270. These medial controls may be implementation dependent and may be based on user preferences at the first device 250. For example, and not by way of limitation, the first device's captured media may be watermarked, the resolution may be reduced, or noise, blur, or cropping may be added to the media. This controlled media may then be what is shared with other devices 250, after application of the one or more media controls. Further, in some embodiments, a media control may set shared media to be automatically removed from group sharing after a predetermined time, so that other member devices 250 have only time limited access to such media.

With another media control, the sharing system 200 may limit how far removed from the first device 250 the media may be shared. With some embodiments, media captured, or otherwise contributed, by the first device 250 may end up being shared indirectly with devices 250 outside the first device's groups 270. For instance, a second device 250 may be in a first group 270 with the first device 250 and may thus receive media from the first device 250. As a member of one of the first device's groups 270, the second device 250 can be considered to be a single degree removed from the first device 250. A third device may not be in any groups 270 with the first device 250, but may be in a second group 270 with the second device 250. Therefore, the third device 250 can be considered to be two degrees removed from the first device 250 and one degree removed from the second device 250. Through that second group 270, the third device 250 may acquire access to the media contributed by the first device 250 as that media may be accessed by and then shared by the second device 250. Accordingly, the sharing system 200 may provide indirect sharing in a cascading manner, where a device 250 may be removed from the first device 250 by multiple degrees but may still acquire access to the first device's media. A user at the first device 250 may, however, want to limit this cascading nature of sharing so as to avoid having his or her media accessible by everyone even distantly connected to him or her. Thus, the sharing system 200 may provide a media control enabling the user to specify how far, i.e., to how many degrees or levels, the media may be shared with other devices 250.

The sharing system 200 can be made particularly effective when the various devices 250 within a group 270 each maintain a continuous or nearly continuous network connection. The network connection may take various forms, including, for example, mobile networks, Wi-Fi, Bluetooth, or a combination of networks. Given a continuous connection, when a first device 250 in the group captures media, such as by taking a photo, the media may quickly appear on a second device 250 in the group 270.

A device 250 may be a member of more than one group 270 at a time. For example, the device 250 may belong to a first group 270 that includes devices 250 of work colleagues, a second group 270 that includes devices of family members, and a third group 270 that includes devices of friends or classmates. Accordingly, a user of a device 250 may set preferences for media sharing. For example, and not by way of limitation, the user may specify sharing folder on the device 250. In that case, a set of one or more folders may be associated with a particular group 270 of the device 250. As a result, media captured and stored in the associated folders may be automatically shared with that particular group 270. Further, media captured and shared on other devices 250 in the group may be deposited, such as by the agent on the first device 250, into such associated folders. In some embodiments, a set of folders may be associated with each group 270 of which the first device 250 is a part. When different folders are associated with different groups, the user of the device 250 may ensure that media captured for the private use of a first group 270 is not accidentally shared with a second group 270.

In some embodiments, other filters may be used to determine which media should be shared and when. Such filters may be maintained as user preferences for the device 250 in question. For example, a user may indicate in the preferences for a device 250 that no media taken at specific time frames, or having specific geolocation tags or other tags, or being of certain media formats or types (e.g., audio, video, photo) may be shared with certain groups 270. It will be understood that the sharing system 200 may be capable of various filtering rules for indicating when and with which devices 250 media is to be shared.

Not all devices 250 in a group 270 need to be capable of capturing media. Rather, a device 250 may be a receiver only, a sender only, or a combination sender and receiver. For example, a networked television may behave as a receiver device 250 within a group 270. In that case, media captured at another device 250 in the group may become accessible on the television. Thus, someone watching the television may view that media. For another example, a digital audio recorder may behave as a sender-only device 250, as it may be incapable of displaying many forms of media other than audio. Some devices may be capable of being both a sender and a receiver, but may be configured through user preferences to behave as only one or the other.

Some embodiments of the sharing system 200 may enable inheritance, where a slave device 250 inherits group membership from a master device 250. In that case, the slave device 250 may behave as if it has all the group memberships of the master device 250. For example, a user may own two cameras, Camera A and Camera B. Camera A may be a member of one or more groups 270. If Camera A is lost or is being replaced with Camera B, the user may want Camera B to replace Camera A as a member of Camera A's various groups 270. The user may specify, such as through the agent 210 of Camera A or B, that Camera B is a slave device 250 to Camera A. In that case, media captured from other devices 250 in Camera A's groups 270 may be automatically shared with Camera B, and media captured by Camera B may be automatically shared with the other devices 250 Camera A's groups 270. In some embodiments, the master device 250 (Camera A, in this example) and the slave device 250 (Camera B) may be treated as independent devices 250 within the groups 270. In this case, a user of the slave device 250 may modify the groups 270 or preferences of the slave device 250, and need not share media with the master device 250. The slave device 250 may thus continue to be part of the applicable groups 270 even if the master device 250 leaves those groups 270.

In some embodiments, the slave device 250 may have a “locked” inheritance from the master device 250. In that case, the slave device 250 may be unable to join groups 270 other than those to which the master device 250 belongs, and may be unable to leave groups 270 to which the master device 250 belongs. In some additional embodiments, the slave device 250 may also be locked into the master device's preferences as well, such as shared folders or filtering preferences, and may be unable to change these. Further, if the master device 250 leaves or joins a group 270, these group changes may likewise be inherited by the slave device 250.

In some embodiments, the slave device 250 may have a “consumer” inheritance from the master device 250. In a consumer inheritance, the slave device 250 may be a consumer of media from the master device 250, without capturing media for sharing itself. Thus, when the master device 250 captures media or receives shared media from the group 270, the slave device 250 may receive access to the captured or shared media. On the other hand, media captured by the slave device 250 need not be shared with the group in this consumer inheritance relationship.

In some embodiments, a group 270 may be a limited group 270, which may be location-limited, time-limited, or limited in some other manner. In a limited group 270, membership may be established at least partially based on some condition. In a time-limited group 270, for example, the group 270 may begin at a specific time, terminate at a specific time, or both. In a location-limited group 270, group membership may be limited to devices 250 in a specific location.

Membership may be further limited by rules instituted by the device 250 initiating a limited group 270. For example, a group 270 may be location-dependent and may also include only those devices 250 that are already members in another, specified group 270. To initiate a location-dependent group 270, a user at a device 250 may specify a location and a radius, where only devices 250 within that radius of the location may be eligible to join the group 270. A device 250 may be required to verify its location to join the group 270, such as by providing access to its GPS or other location-determining aspect of the device 250. Location-limited groups 270 may be particularly useful in the case of events. With such a group 270, some or all devices 250 of users at an event may be enabled to share media, such as photos, videos, and audio captured at the event.

Groups 270 may be terminated by various means. For example, in the case of a time-limited group 270, the group may automatically terminate at the specified time. In some cases, a group 270 may terminate when a group administrator, which may be a user or a device 250, indicates to the sharing system 200 that the group 270 is to be terminated. After termination, a first device 250 that was a member of such group 270 may lose access to media captured by other group members. Likewise, if a first device 250 leaves a group 270 that still exists with other member devices 250, the first device 250 may lose access to media captured by the other member devices 250. If such media captured by others is stored locally on the first device 250, then a digital rights management (DRM) technique may be used to remove the media from the first device 250.

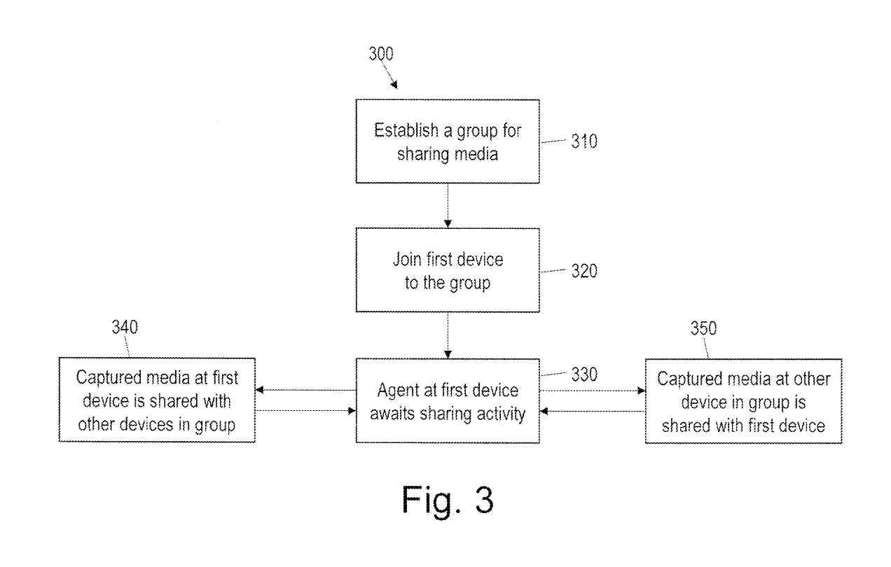

FIG. 3 is a flow diagram of a method 300 for sharing media between devices 250, according to some embodiments of this disclosure. As shown, at block 310, a group 270 may be established for media sharing. At block 320, a first device 250 may join the group 270, which contains one or more other member devices 250. At block 330, an agent 210 at the first device 250 may await sharing activity. If the first device 250 captures media that meets predetermined sharing preferences, then at block 340, the agent 210 may share that media with other devices 250 in the group 270. If another device 250 in the group 270 shares media with the group 270, then at block 350, the agent 210 may receive that shared media, or access to that shared media, and make it available on the first device 250. It will be understood that this method 300 may be modified to suit the various circumstances of media sharing, or according to implementation of the sharing system 200.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
joining a first device to a first group of one or more other devices;
determining that a first set of filtering conditions is met by media contributed by the first device;
applying, by a computer processor, a media control to the contributed media to provide controlled media, wherein the controlled media is a controlled version of the contributed media, and wherein the media control application is performed automatically in response to the first set of filtering conditions for the contributed media being met; and
sharing the controlled media with the other devices in the first group, automatically in response to the first set of filtering conditions for the contributed media being met.

2. The method of claim 1, wherein applying the media control to the contributed media to provide the controlled media comprises applying to the contributed media at least one of blurring, watermarking, cropping, adding noise, and reducing resolution.

3. The method of claim 1, wherein applying the media control to the contributed media to provide the controlled media comprises:
enabling the one or more other devices in the first group to further share the controlled media with an additional one or more devices outside the first group; and
limiting the sharing of the controlled media to a maximum degree of separation between the first device and the additional devices allowed to the receive the controlled media.

4. The method of claim 1, further comprising:
requiring that the first device be located in a predetermined region before joining the first device to the first group; and
removing the first device from the first group when the first device leaves the predetermined region.

5. The method of claim 1, further comprising:
receiving access to shared media from a second device in the first group; and
removing the access to the shared media automatically when at least one of the first device and the second device leaves the first group.

6. The method of claim 1, further comprising:
associating the first device with a slave device;
receiving access to shared media from a second device in the first group; and
automatically providing to the slave device access to the shared media from the second device, due to the association of the first device with the slave device.

7. The method of claim 1, further comprising:
joining the first device to a second group of one or more other devices;
applying the media control to new media contributed by the first device, to provide a controlled new media, wherein the controlled new media is a controlled version of the new media;
sharing the controlled new media with the other devices in the first group, automatically if the first set of filtering conditions for the new media are met; and
sharing the controlled new media with the other devices in the second group, automatically if a second set of filtering conditions for the new media are met.

8. A system comprising:
a group manager configured to join a first device to a first group of one or more other devices, and to determine that a first set of filtering conditions is met by media contributed by the first device;
a media controller configured to apply a media control to the contributed media to provide controlled media, wherein the controlled media is a controlled version of the contributed media, and wherein the media control application is performed automatically in response to the first set of filtering conditions for the contributed media being met; and
a communications manager configured to share the controlled media with the other devices in the first group, automatically in response to the first set of filtering conditions for the contributed media being met.

9. The system of claim 8, the media controller being further configured to apply the media control to the contributed media to provide the controlled media by applying to the contributed media at least one of blurring, watermarking, cropping, adding noise, and reducing resolution.

10. The system of claim 8, wherein, in applying the media control to the contributed media to provide the controlled media, the media controller is configured to:
enable the one or more other devices in the first group to further share the controlled media with an additional one or more devices outside the first group; and
limit the sharing of the controlled media to a maximum degree of separation between the first device and the additional devices allowed to the receive the controlled media.

11. The system of claim 8, the group manager being further configured to
require that the first device be located in a predetermined region before joining the first device to the first group; and
remove the first device from the first group when the first device leaves the predetermined region.

12. The system of claim 8, the communications manager being further configured to receive access to shared media from a second device in the first group, and to remove the access to the shared media automatically when at least one of the first device and the second device leaves the first group.

13. The system of claim 8, the group manager being further configured to associate the first device with a slave device, and the communications manager being further configured to receiving access to shared media from a second device in the first group and to automatically provide to the slave device access to the shared media from the second device, due to the association of the first device with the slave device.

14. The system of claim 8, the group manager being further configured to join the first device to a second group of one or more other devices, the media controller being further configured to apply the media control to new media contributed by the first device, so as to provide controlled new media, wherein the controlled new media is a controlled version of the new media, and the communications manager being further configured to:
share the controlled new media with the other devices in the first group, automatically if the first set of filtering conditions for the new media are met; and
share the controlled new media with the other devices in the second group, automatically if a second set of filtering conditions for the new media are met.

15. A computer program product comprising a computer readable storage medium having computer readable program code embodied thereon, the computer readable program code executable by a processor to perform a method comprising:
joining a first device to a first group of one or more other devices;
determining that a first set of filtering conditions is met by media contributed by the first device;
applying a media control to the contributed media to provide controlled media, wherein the controlled media is a controlled version of the contributed media, and wherein the media control application is performed automatically in response to the first set of filtering conditions for the contributed media being met; and
sharing the controlled media with the other devices in the first group, automatically in response to the first set of filtering conditions for the contributed media being met.

16. The computer program product of claim 15, wherein applying the media control to the contributed media to provide the controlled media comprises applying to the contributed media at least one of blurring, watermarking, cropping, adding noise, and reducing resolution.

17. The computer program product of claim 15, wherein applying the media control to the contributed media to provide the controlled media comprises:
enabling the one or more other devices in the first group to further share the controlled media with an additional one or more devices outside the first group; and
limiting the sharing of the controlled media to a maximum degree of separation between the first device and the additional devices allowed to the receive the controlled media.

18. The computer program product of claim 15, the method further comprising:
requiring that the first device be located in a predetermined region before joining the first device to the first group; and
removing the first device from the first group when the first device leaves the predetermined region.

19. The computer program product of claim 15, the method further comprising:
receiving access to shared media from a second device in the first group; and
removing the access to the shared media automatically when at least one of the first device and the second device leaves the first group.

20. The computer program product of claim 15, the method further comprising:
joining the first device to a second group of one or more other devices;
applying the media control to new media contributed by the first device, to provide controlled new media, wherein the controlled new media is a controlled version of the new media;
sharing the controlled new media with the other devices in the first group, automatically if the first set of filtering conditions for the new media are met; and
sharing the controlled new media with the other devices in the second group, automatically if a second set of filtering conditions for the new media are met.
